(19) United States
(12) Patent Application Publication
(10) Pub. No.: US 2026/0034577 A1
(43) Pub. Date: Feb. 5, 2026

(54) APPARATUS AND METHOD FOR MANUFACTURING BATTERY

(71) Applicant: SK On Co., Ltd., Seoul (KR)

(72) Inventors: Won Je OH, Seoul (KR); Hye Been SON, Seoul (KR); Jae Sik SHIN, Seoul (KR)

(21) Appl. No.: 19/283,240

(22) Filed: Jul. 29, 2025

(30) Foreign Application Priority Data
Jul. 30, 2024 (KR) 10-2024-0100763

(51) Int. Cl. B21D 11/10; H01M 10/04

(52) U.S. Cl. CPC B21D 11/10; H01M 10/0422; H01M 10/0431

(57) ABSTRACT

An apparatus for manufacturing a battery and a manufacturing method using the same are disclosed. According to one aspect of the present disclosure, there is provided an apparatus for manufacturing a battery, which includes a housing, an angle adjuster provided to be movable with respect to the housing, and a forming part that is disposed between the housing and the angle adjuster and has an arrangement angle that varies according to movement of the angle adjuster to bend a plurality of electrode tabs provided in an electrode assembly.

### CROSS-REFERENCE TO RELATED APPLICATION

This application claims priority to and the benefit of Korean Patent Application No. 10-2024-0100763, filed on Jul. 30, 2024, the disclosure of which is incorporated herein by reference in its entirety.

### BACKGROUND

### 1. Field of the Invention

Embodiments of the present disclosure relate to an apparatus and method for manufacturing a battery.

### 2. Discussion of Related Art

Secondary batteries (hereinafter referred to as “batteries”) are known as one of the energy storage means that can be charged and discharged. Batteries are widely used in various fields that use electrical energy. For example, the batteries are widely used in the field of mobile devices, such as mobile phones, notebooks, tablets, etc., and are being sought for wider use in the field of transportation, such as vehicles, aircraft, ships, etc. In addition, demand for batteries is also increasing in the field of energy storage systems (ESSs) for using surplus electricity.

Some batteries can be formed in a structure in which an electrode assembly, electrolyte, etc. are accommodated inside a case. In some cases, the electrode assembly can be wound around an axis. That is, the electrode assembly can be processed into a sheet shape by arranging positive and negative electrodes with a separator interposed therebetween, and the sheet-shaped electrode assembly can be wound around an axis to produce a substantially cylindrical electrode assembly.

The electrode assembly may have electrode tabs for electrical connection with electrode terminals. In some batteries, the electrode tab of each electrode may be provided as a plurality of electrode tabs. Specifically, the electrode tab may be formed in a kind of flag shape, and a plurality of electrode tabs may be disposed along an end portion of the electrode assembly. The plurality of electrode tabs may be bent toward a center axis of the electrode assembly during the processing. The plurality of bent electrode tabs may form a connecting surface for electrically connecting a current collector or the like on one surface of the electrode assembly.

### SUMMARY OF THE INVENTION

Some embodiments of the present disclosure may provide an apparatus and method for manufacturing a battery.

In addition, some embodiments of the present disclosure may provide an apparatus and method for manufacturing a battery, which may be used to bend a plurality of electrode tabs during a process of manufacturing an electrode assembly.

In addition, some embodiments of the present disclosure may provide an apparatus and method for manufacturing a battery, which are capable of increasing a process speed.

In addition, some embodiments of the present disclosure may provide an apparatus and method for manufacturing a battery, which are capable of improving processing quality.

In addition, some embodiments of the present disclosure may provide an apparatus and method for manufacturing a battery, which are capable of improving the performance or quality of a processed battery.

Some embodiments of the present disclosure can be widely applied in green technology fields, such as electric vehicles, battery charging stations, solar power generation and wind power generation using batteries, etc. In addition, some embodiments of the present disclosure can be used in eco-friendly electric vehicles, hybrid vehicles, etc. to prevent climate change by suppressing air pollution and greenhouse gas emissions.

According to one embodiment of the present disclosure, there is provided an apparatus for manufacturing a battery, which includes a housing, an angle adjuster provided to be movable with respect to the housing, and a forming part disposed between the housing and the angle adjuster and having an arrangement angle that varies according to movement of the angle adjuster to bend a plurality of electrode tabs provided in an electrode assembly.

The housing may include an internal space in which the angle adjuster and the forming part are disposed.

The housing may be provided to be rotatable with respect to the electrode assembly about a rotation axis in a first direction.

The angle adjuster may be disposed in a central portion of the housing and provided to be movable in a first direction with respect to the housing.

The angle adjuster may be provided to gradually move from an initial position toward the electrode assembly according to rotation of the housing to change the arrangement angle of the forming part.

The forming part may include a first end portion fastened to the housing. The first end portion may be rotatably fastened to the housing through a first hinge shaft.

The first hinge shaft may be provided to be orthogonal to a movement direction of the angle adjuster.

The forming part may include a second end portion fastened to the angle adjuster. The second end portion may be rotatably fastened to the angle adjuster through a second hinge shaft.

The second hinge shaft may be provided to be orthogonal to a movement direction of the angle adjuster.

The second hinge shaft may be movably fastened to a slot disposed in the second end portion. The slot may be formed to extend in a longitudinal direction of the forming part.

The second hinge shaft may be formed to move within the slot in conjunction with the movement of the angle adjuster.

The forming part may include a first end portion rotatably fastened to the housing through a first hinge shaft, and a second end portion rotatably fastened to the angle adjuster through a second hinge shaft. The second hinge shaft may be movably fastened to a slot disposed in the second end portion and move within the slot according to the movement of the angle adjuster.

The forming part may include a pressing surface that comes into contact with the electrode tab. At least a part of the pressing surface may have a curved surface to relieve damage to the electrode tab during bending of the electrode tab.

The pressing surface may include a coating layer.

The forming part may be provided as a plurality of forming parts. The plurality of forming parts may be provided to repeatedly bend the electrode tab according to rotation of the housing.

According to one embodiment of the present disclosure, there is provided a method of manufacturing a battery, which includes inputting an electrode assembly in which a plurality of electrode tabs are disposed on at least one surface thereof, and bending, by a forming part, the plurality of electrode tabs. The bending of the plurality of electrode tabs may be performed while an arrangement angle of the forming part is gradually changed.

The bending of the plurality of electrode tabs may include moving the forming part in a circumferential direction of the electrode assembly while preferentially coming into contact with the electrode tab disposed on an outer circumferential side of the electrode assembly, and gradually changing the arrangement angle of the forming part and moving the forming part in the circumferential direction while coming into contact with the electrode tab disposed on an inner circumferential side of the electrode assembly.

The forming part may be provided as a plurality of forming parts. The bending of the plurality of electrode tabs may be performed to repeatedly bend the electrode tab while the plurality of forming parts move in a circumferential direction of the electrode assembly.

The method may further include pressing, by the forming part, the plurality of bent electrode tabs.

The pressing of the plurality of bent electrode tabs may be performed in such a manner that the forming part is disposed in a direction orthogonal to a winding axis of the electrode assembly and the forming part moves in the circumferential direction centered on the winding axis.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a schematic perspective view illustrating an example of an electrode assembly manufacturing process;

FIG. 2 is a schematic perspective view illustrating an electrode assembly manufactured through the manufacturing process of FIG. 1;

FIG. 3 is a schematic perspective view illustrating an apparatus for manufacturing a battery according to one embodiment of the present disclosure;

FIG. 4 is a first operation state diagram illustrating the operation of the apparatus for manufacturing a battery illustrated in FIG. 3;

FIG. 5 is a second operation state diagram illustrating the operation of the apparatus for manufacturing a battery illustrated in FIG. 3;

FIGS. 6A to 6C are schematic perspective views illustrating modified examples of a forming part illustrated in FIG. 3;

FIG. 7 is a schematic perspective view illustrating an apparatus for manufacturing a battery according to another embodiment of the present disclosure;

FIG. 8 is a schematic perspective view illustrating an apparatus for manufacturing a battery according to still another embodiment of the present disclosure; and

FIGS. 9A and 9B are schematic flowcharts illustrating a method of manufacturing a battery according to one embodiment of the present disclosure.

### DETAILED DESCRIPTION OF EXEMPLARY EMBODIMENTS

Hereinafter, the present disclosure will be described in detail with reference to the accompanying drawings. However, this is merely exemplary, and the present disclosure is not limited to specific embodiments exemplarily described.

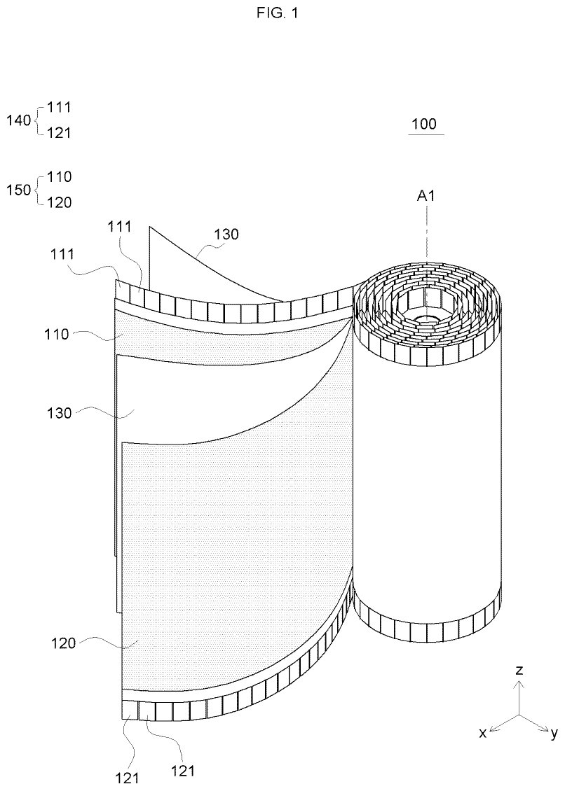

FIG. 1 is a schematic perspective view illustrating an example of an electrode assembly manufacturing process.

For convenience of description, hereinafter, a z-axis direction is referred to as a vertical direction based on the coordinate axes illustrated in FIG. 1 and the like. In addition, based on a winding axis A1 (a z-axis) around which an electrode assembly 100 is wound, a direction C1 orthogonal to the winding axis A1 is referred to as a radial direction, and a rotational direction C2 centered on the winding axis A is referred to as a circumferential direction.

Referring to FIG. 1, in some embodiments, a battery may include the electrode assembly 100. The electrode assembly 100 may include a positive electrode sheet 110 and a negative electrode sheet 120 that are disposed with a separator 130 interposed therebetween. In some embodiments, the electrode assembly 100 may have a roll shape in which the positive electrode sheet 110, the negative electrode sheet 120, and the separator 130 are wound around the winding axis A1. In some cases, the electrode assembly 100 wound in a roll shape in this way may be referred to as a “jelly roll” in the art.

In some embodiments, the positive electrode sheet 110 may include a positive electrode current collector and a positive electrode mixture layer disposed on at least one surface of the positive electrode current collector. For example, the positive electrode current collector may include aluminum, stainless steel, nickel, titanium, an alloy thereof, etc. Alternatively, the positive electrode current collector may include aluminum, stainless steel, etc. that are surface-treated with carbon, nickel, titanium, silver, etc. In some embodiments, the positive electrode mixture layer may include a positive electrode active material. The positive electrode active material may include a compound capable of reversibly intercalating and deintercalating lithium ions. For example, the positive electrode active material may include lithium-nickel metal oxide. In some cases, at least one of cobalt (Co), manganese (Mn), and aluminum (Al) may be further included in the lithium-nickel metal oxide. In some embodiments, the positive electrode material layer may further include a binder, and optionally, may further include a conductive agent, a thickener, etc.

Meanwhile, in some embodiments, the negative electrode sheet 120 may include a negative electrode current collector and a negative electrode mixture layer disposed on at least one surface of the negative electrode current collector. For example, the negative electrode current collector may include copper, stainless steel, nickel, titanium, nickel foam, copper foam, a polymer substrate coated with a conductive metal, etc. In some embodiments, the negative electrode mixture layer may include a negative electrode active material. The negative electrode active material may include a compound capable of reversibly intercalating and deintercalating lithium ions. For example, the negative electrode active material may include a carbon-based material, such as crystalline carbon, amorphous carbon, a carbon composite, carbon fiber, etc., lithium metal, a lithium alloy, a silicon (Si)-containing material or a tin (Sn)-containing material, etc. In some embodiments, the negative electrode mixture layer may further include a binder, and optionally, may further include a conductive agent, a thickener, etc.

The separator 130 may be disposed between the positive electrode sheet 110 and the negative electrode sheet 120. The separator 130 may be formed to limit an electrical short circuit between the positive electrode sheet 110 and the negative electrode sheet 120 and to allow ions to flow. In some embodiments, the separator 130 may include a porous polymer film or a porous nonwoven fabric. For example, the porous polymer film may include polyolefin-based polymers, such as an ethylene polymer, a propylene polymer, an ethylene/butene copolymer, an ethylene/hexene copolymer, an ethylene/methacrylate copolymer, etc. The porous nonwoven fabric may include high-melting point glass fibers, polyethylene terephthalate fibers, etc. In some cases, the separator may include a ceramic-based material. For example, inorganic particles may be applied on the polymer film or dispersed in the polymer film to improve heat resistance. In some embodiments, the separator may have a single-layer or multilayered structure including the polymer film and/or the nonwoven fabric.

In some embodiments, the battery may be provided in a cylindrical shape. In addition, the electrode assembly 100 may be wound in a corresponding cylindrical shape. The cylindrical battery may have a predetermined diameter and height. For example, the battery may have a diameter of about 46 mm and a height of about 80 mm. In some cases, the battery having such a form factor may be referred to as a “4680 battery.” In another example, the battery may have a diameter of about 46 mm and a height of 80 mm, or a diameter of about 46 mm and a height of 95 mm, or a diameter of about 46 mm and a height of 110 mm. In some cases, the battery having such a form factor may be referred to as a “46xx battery.” In the “46xx,” “xx” may describe the height of the corresponding form factor. In still another example, the battery may have a diameter of about 48 mm and a height of 75 mm, or a diameter of about 48 mm and a height of 80 mm, or a diameter of about 48 mm and a height of 110 mm. In some cases, the battery having such a form factor may be referred to as a “48xx battery.” In the “48xx,” “xx” may describe the height of the corresponding form factor. However, the diameter and height of the exemplified battery may be modified in various ways as needed and are not necessarily limited to those exemplified.

Meanwhile, in some embodiments, the electrode assembly 100 may include a positive electrode tab 111 and a negative electrode tab 121. The positive electrode tab 111 may be formed on one end of the positive electrode current collector from which the positive electrode mixture layer is omitted. In the illustrated embodiment, the positive electrode tab 111 is disposed along an upper end of the positive electrode sheet 110. Similarly, the negative electrode tab 121 may be formed on one end of the negative electrode current collector from which the negative electrode mixture layer is omitted. In the illustrated embodiment, the negative electrode tab 121 is disposed along a lower end of the negative electrode sheet 120.

In some embodiments, the positive electrode tab 111 may be provided as a plurality of positive electrode tabs. In addition, the plurality of positive electrode tabs 111 may be disposed in a direction in which the positive electrode sheet 110 is wound. In the illustrated embodiment, the plurality of positive electrode tabs 111 are disposed along an upper edge of the positive electrode sheet 110. Similarly, the negative electrode tab 121 may be provided as a plurality of negative electrode tabs. In addition, the plurality of negative electrode tabs 121 may be disposed in a direction in which the negative electrode sheet 120 is wound. In the illustrated embodiment, the plurality of negative electrode tabs 121 are disposed along a lower edge of the negative electrode sheet 120.

For convenience of description, hereinafter, the positive electrode tab 111 or the negative electrode tab 121 will be collectively referred to as an “electrode tab 140.” In the following description, the electrode tab 140 may be used to refer to the positive electrode tab 111 or the negative electrode tab 121. In addition, the positive electrode sheet 110 or the negative electrode sheet 120 will be collectively referred to as an “electrode sheet 150.” In the following description, the electrode sheet 150 may be used to refer to the positive electrode sheet 110 or the negative electrode sheet 120.

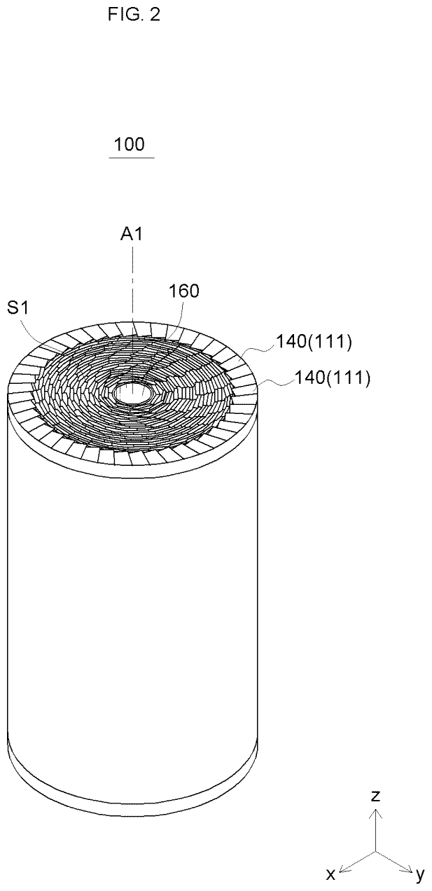

FIG. 2 is a schematic perspective view illustrating an electrode assembly manufactured through the manufacturing process of FIG. 1.

Referring to FIG. 2, in some embodiments, the electrode assembly 100 may have a substantially cylindrical shape in which the positive electrode sheet 110, the negative electrode sheet 120, and the separator 130 are wound around the winding axis A1. In addition, in some embodiments, the electrode tab 140 may be bent toward the winding axis A1. That is, in the illustrated embodiment, the plurality of positive electrode tabs 111 disposed on an upper end of the electrode assembly 100 may be bent toward the winding axis A1.

The plurality of bent positive electrode tabs 111 may form a predetermined connecting surface S1 on the upper end of the electrode assembly 100. The connecting surface S1 may be an upper surface area of the electrode assembly 100 formed by bending the plurality of positive electrode tabs 111. In the illustrated embodiment, the connecting surface S1 is formed in a substantially circular shape, and a hollow 160 is disposed in a central portion corresponding to the winding axis A1. In some embodiments, the connecting surface S1 may be used for electrically connecting the positive electrode current collector to a positive electrode terminal. For example, a current collector coupled to the positive electrode terminal may be welded to the connecting surface S1. Alternatively, in some cases, the positive electrode terminal may be directly electrically connected to the connecting surface S1.

Meanwhile, although not illustrated, the negative electrode tab 121 may also be bent in a similar manner to form a connecting surface and electrically connected to a negative electrode terminal.

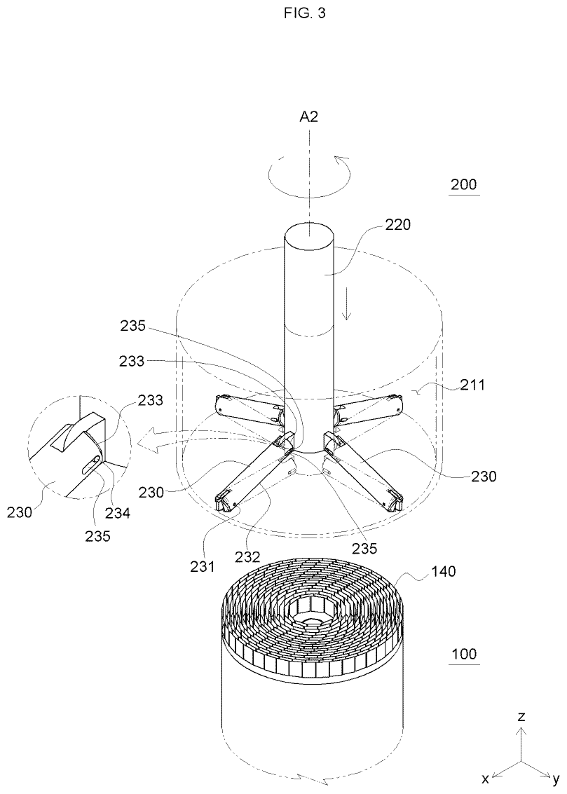

FIG. 3 is a schematic perspective view illustrating an apparatus for manufacturing a battery according to one embodiment of the present disclosure.

Referring to FIG. 3, in some embodiments, the electrode tab 140 may be bent through an apparatus 200 for manufacturing a battery. In some embodiments, the apparatus 200 for manufacturing a battery may include a housing 210. In addition, the apparatus 200 for manufacturing a battery may include an angle adjuster 220 that is provided to be movable with respect to the housing 210. In addition, the apparatus 200 for manufacturing a battery may include a forming part 230 that is disposed between the housing 210 and the angle adjuster 220 and changes an arrangement angle according to the movement of the angle adjuster 220 to bend the plurality of electrode tabs 140 provided in the electrode assembly 100.

Specifically, in some embodiments, the apparatus 200 for manufacturing a battery may include the housing 210. The housing 210 may form the overall exterior of the apparatus 200 for manufacturing a battery. In the illustrated embodiment, the housing 210 is exemplified as having a substantially cylindrical exterior. However, the exterior of the housing 210 may be modified in various ways as needed and is not necessarily limited to the exemplified shape.

In some embodiments, the housing 210 may have an internal space 211 in which the angle adjuster 220 and the forming part 230 are disposed.

In the illustrated embodiment, the housing 210 may have a substantially cylindrical exterior, and the internal space 211 may be formed inside the cylindrical shape. The angle adjuster 220 and the forming part 230 may be disposed in the internal space 211. In the illustrated embodiment, the angle adjuster 220 is disposed to extend generally vertically in a central portion of the internal space 211. In addition, the forming part 230 is disposed in a lower area of the internal space 211 and is link-coupled to the angle adjuster 220.

In some embodiments, the housing 210 may be formed with an open bottom structure. That is, the housing 210 may have an opening at a lower side thereof. In this case, the forming part 230 may be exposed through the opening at the lower side of the housing 210 and approach the electrode tab 140.

In some embodiments, the housing 210 may be provided to be rotatable with respect to the electrode assembly 100 about a rotation axis A2 in a first direction.

Specifically, in some embodiments, the housing 210 may have the rotation axis A2 in the first direction. In the above, the first direction may be a direction corresponding to the winding axis A1 of the electrode assembly 100. For example, in the illustrated embodiment, the first direction may be a vertical direction corresponding to a z-axis direction. In addition, in some embodiments, the rotation axis A2 may be arranged at the center of the housing 210. The electrode assembly 100 may be positioned such that the winding axis A1 corresponds to the rotation axis A2 of the housing 210 for processing the electrode tab 140.

In some embodiments, the housing 210 may be rotated about the rotation axis A2. Although not illustrated, in some embodiments, the housing 210 may be coupled to a driving part, such as a motor for rotation or the like. In some embodiments, the housing 210 may be rotated with respect to the electrode assembly 100. For example, the housing 210 may be rotated about the rotation axis A2 with respect to the fixed electrode assembly 100. In some cases, the electrode assembly 100 may be rotated with respect to the housing 210. For example, the housing 210 may be fixed, and the electrode assembly 100 may be rotated about the rotation axis A2.

In some embodiments, the housing 210 may be provided to move up and down with respect to the electrode assembly 100. In addition, in some embodiments, the housing 210 may be provided to move in a front-rear direction and/or a left-right direction with respect to the electrode assembly 100. Accordingly, the housing 210 may be disposed at an appropriate location for processing the electrode assembly 100. In some cases, the movement of the housing 210 may be replaced by the movement of the electrode assembly 100.

Meanwhile, in some embodiments, the apparatus 200 for manufacturing a battery may include the angle adjuster 220. The angle adjuster 220 may be provided to be movable with respect to the housing 210. For example, in the illustrated embodiment, the angle adjuster 220 is provided to move up and down with respect to the housing 210. Although not illustrated, in some embodiments, the angle adjuster 220 may be coupled to a driving part, such as an actuator or the like for movement.

In some embodiments, the angle adjuster 220 may be disposed in the central portion of the housing 210 and provided to be movable in the first direction with respect to the housing 210. That is, in the illustrated embodiment, the angle adjuster 220 may be provided to move up and down with respect to the housing 210.

Specifically, in some embodiments, the angle adjuster 220 may be disposed in the central portion of the housing 210. For example, in the illustrated embodiment, the angle adjuster 220 is disposed in the central portion of the housing 210 that is substantially circular in a plan view. In addition, in some embodiments, the angle adjuster 220 may be formed to vertically extend a predetermined length in the internal space 211. In addition, in some embodiments, the angle adjuster 220 may be disposed at a location corresponding to the rotation axis A2 of the housing 210 or the winding axis A1 of the electrode assembly 100. The above arrangement of the angle adjuster 220 can contribute to simplifying the structure of the apparatus 200 for manufacturing a battery and effectively transmitting a pressing force.

Meanwhile, in some embodiments, the apparatus 200 for manufacturing a battery may include the forming part 230. The forming part 230 may be provided to come into contact with the electrode tab 140 provided in the electrode assembly 100 and bend the electrode tab 140. That is, the electrode tab 140 may be bent toward the winding axis A1 by the forming part 230. In some embodiments, the forming part 230 may be fastened between the housing 210 and the angle adjuster 220. For example, in the illustrated embodiment, the forming part 230 has one end that faces the rotation axis A2 and is fastened to the angle adjuster 220 and an opposite end fastened to an inner wall of the housing 210.

In some embodiments, the forming part 230 may be provided so that the arrangement angle varies according to the movement of the angle adjuster 220. For example, the arrangement angle may be an angle formed by the forming part in a longitudinal direction with respect to a transverse plane. In some embodiments, the arrangement angle of the forming part 230 may be determined by the location of the angle adjuster 220. For example, in the illustrated embodiment, the arrangement angle of the forming part 230 may gradually decrease as the angle adjuster 220 moves down and may gradually increase as the angle adjuster 220 moves up.

In some embodiments, the angle adjuster 220 may be provided to gradually move from an initial position toward the electrode assembly 100 according to the rotation of the housing 210 to change the arrangement angle of the forming part 230.

Specifically, the angle adjuster 220 may gradually move down from the initial position toward the electrode assembly 100 when the housing 210 rotates. Alternatively, the angle adjuster 220 may gradually move down from the initial position when the forming part 230 comes into contact with the electrode tab 140 and the housing 210 rotates. In some embodiments, the initial position may refer to a state in which the angle adjuster 220 has moved upward. That is, the initial position may refer to a state in which the angle adjuster 220 moves up and the forming part 230 is disposed to be inclined downward toward an outer side in a radial direction centered on the rotation axis A2. For example, the initial position may correspond to the position of the angle adjuster 220 illustrated in FIG. 3.

In some embodiments, the vertical movement of the angle adjuster 220 may change the arrangement angle of the forming part 230. For example, in the illustrated embodiment, when the angle adjuster 220 moves down from the initial position, the arrangement angle of the forming part 230 may gradually decrease. In this case, the forming part 230 may gradually approach the electrode tab 140. Conversely, when the angle adjuster 220 moves up from the lowered position, the arrangement angle of the forming part 230 may gradually increase. In this case, the forming part 230 may gradually move away from the electrode tab 140. The angle adjuster 220 may move up or down in the above manner to adjust the arrangement angle of the forming part 230.

Meanwhile, in some embodiments, the forming part 230 may include a first end portion 231 fastened to the housing 210. In addition, the first end portion 231 may be rotatably connected to the housing 210 through a first hinge shaft 232. In addition, in some embodiments, the first hinge shaft 232 may be provided to be orthogonal to a movement direction of the angle adjuster 220.

Specifically, in some embodiments, the forming part 230 may be formed to extend in the longitudinal direction. For example, the forming part 230 may have a bar shape extending substantially in the longitudinal direction. In some embodiments, the forming part 230 may be disposed generally in the radial direction centered on the rotation axis A2. In addition, in some embodiments, the forming part 230 may have the first end portion 231 at one side in the longitudinal direction. In the illustrated embodiment, the first end portion 231 is provided at an outer end in the radial direction centered on the rotation axis A2. In some embodiments, the first end portion 231 may be rotatably fastened to the housing 210 through the first hinge shaft 232. Accordingly, the forming part 230 may be rotated with respect to the housing 210 about the first hinge shaft 232.

In addition, in some embodiments, the first hinge shaft 232 may be provided to be orthogonal to the movement direction of the angle adjuster 220. That is, in the illustrated embodiment, the first hinge shaft 232 may be provided as a transverse axis corresponding to an xy plane. In some embodiments, the transverse direction may be a direction orthogonal to the rotation axis A2 of the housing 210.

Meanwhile, in some embodiments, the forming part 230 may include a second end portion 233 fastened to the angle adjuster 220. The second end portion 233 may be rotatably fastened to the housing 210 through the second hinge shaft 234. In addition, in some embodiments, the second hinge shaft 234 may be provided to be orthogonal to the movement direction of the angle adjuster 220.

Specifically, in some embodiments, the forming part 230 may include the second end portion 233. In the illustrated embodiment, the second end portion 233 is disposed toward the rotation axis A2. The second end portion 233 may be rotatably fastened to the angle adjuster 220 through the second hinge shaft 234. Accordingly, the forming part 230 may be rotated with respect to the angle adjuster 220 about the second hinge shaft 234. In addition, since the first end portion 231 is rotatably fastened to the housing 210, the arrangement of the forming part 230 may vary between the housing 210 and the angle adjuster 220 according to the vertical movement of the angle adjuster 220. That is, the arrangement angle of the forming part 230 may vary according to the vertical movement of the angle adjuster 220.

In some embodiments, the second hinge shaft 234 may be provided to be orthogonal to the movement direction of the angle adjuster 220. That is, in the illustrated embodiment, the second hinge shaft 234 may be provided as a transverse axis corresponding to an xy plane. In some embodiments, the transverse direction may be a direction orthogonal to the rotation axis A2 of the housing 210.

In some embodiments, the second hinge shaft 234 may be moved according to the movement of the angle adjuster 220 and disposed on a different plane from the first hinge shaft 232 according to the operating state. For example, in the illustrated state, the second hinge shaft 234 is positioned at a predetermined higher position than the first hinge shaft 232.

Meanwhile, in some embodiments, the second hinge shaft 234 may be movably fastened to a slot 235 disposed in the second end portion 233. In addition, the slot 235 may be formed to extend in the longitudinal direction of the forming part 230. In addition, in some embodiments, the second hinge shaft 234 may be provided to move within the slot 235 in conjunction with the movement of the angle adjuster 220.

Specifically, in some embodiments, the second end portion 233 may be provided with the slot 235. The slot 235 may be formed to extend in the longitudinal direction of the forming part 230. Alternatively, the slot 235 may be formed to extend in the radial direction centered on the rotation axis A2. In some embodiments, the second hinge shaft 234 may be disposed in the slot 235 and provided to be movable along the slot 235. Accordingly, the second end portion 233 may be rotatable with respect to the angle adjuster 220 about the second hinge shaft 234, while moving in a direction that approaches or moves away from the angle adjuster 220 through the slot 235.

The slot 235 may be modified in various ways as long as it can guide the longitudinal movement of the forming part 230. For example, the slot 235 may include a hole, groove, mechanical shape, etc. to which the second hinge shaft 234 is movably fastened. In addition, in some cases, the slot 235 may be replaced through a rail, a linear guide, etc. In addition, in some cases, the slot 235 may be disposed in the angle adjuster 220, a separate link component, etc. rather than the forming part 230.

Meanwhile, in some embodiments, the second hinge shaft 234 may move along the slot 235. Specifically, the second hinge shaft 234 may be restrained to the angle adjuster 220 and may move up and down according to the vertical movement of the angle adjuster 220. In addition, the second hinge shaft 234 may be fastened to the slot 235 and may move along the slot 235 within the slot 235.

Meanwhile, in some embodiments, the forming part 230 may include the first end portion 231 rotatably fastened to the housing 210 through the first hinge shaft 232. In addition, the forming part 230 may include the second end portion 233 rotatably fastened to the angle adjuster 220 through the second hinge shaft 234. In addition, the second hinge shaft 234 may be movably fastened to the slot 235 disposed in the second end portion 233 and may move within the slot 235 according to the movement of the angle adjuster 220. The forming part 230 is as described above.

In some embodiments, the forming part 230 may include a pressing surface 236 that comes into contact with the electrode tab 140. In addition, at least a part of the pressing surface 236 may be formed as a curved surface to reduce damage to the electrode tab 140 when the electrode tab 140 is bent. In some embodiments, the pressing surface 236 may include a coating layer.

Specifically, in some embodiments, the forming part 230 may include the pressing surface 236 that comes into contact with the electrode tab 140. In the illustrated embodiment, the pressing surface 236 is provided on a bottom surface of the forming part 230. The pressing surface 236 may be one surface of the forming part 230 that comes into contact with the electrode tab 140 and bends or presses the electrode tab.

In some embodiments, the pressing surface 236 may be provided with a gentle curved shape. For example, the pressing surface 236 may be formed as an arc-shaped curved surface with a predetermined curvature with the longitudinal direction of the forming part 230 as an axis. The pressing surface 236 may serve to prevent damage to the electrode tab 140 during a process of bending or pressing the electrode tab 140. In addition, in some embodiments, the forming part 230 may come into contact with or press the electrode tab 140 while rotating about the rotation axis A2, and in this case, the curved pressing surface 236 may serve more effectively to prevent damage to the electrode tab 140.

In addition, in some embodiments, the pressing surface 236 may include a coating layer. The coating layer may replace the above curved shape or may be applied along with the curved shape. In some embodiments, the coating layer may include a coating of a resin material having relatively good durability and a low coefficient of friction. For example, the coating layer may include a fluororesin-based coating, such as polytetrafluoroethylene (PTFE), perfluoroalkoxy (PFA), ethylenetetrafluoroethylene (ETFE), polyvinylidene fluoride (PVDF), polychlorotrifluoroethylene (PCTFE), ethylenechlorotrifluoroethylene (ECTFE), TFE/PDD (Tetrafluoroethylene/Perfluoro), polyvinyl fluoride (PVF), etc.

In some embodiments, the pressing surface 236 may be formed to extend sufficiently in the transverse direction so as to come into contact with all of the plurality of electrode tabs 140. For example, since the pressing surface 236 rotates about the rotation axis A2 to bend the plurality of electrode tabs 140, the pressing surface 236 may be provided to have a length that is a predetermined amount greater than a radius of the connecting surface S1 formed by the plurality of electrode tabs 140. That is, the pressing surface 236 may be formed to extend a predetermined amount longer than the radius of the connecting surface S1.

Meanwhile, in some embodiments, the forming part 230 may be provided as a plurality of forming parts. In addition, the plurality of forming parts 230 may be provided to repeatedly bend the electrode tab 140 according to the rotation of the housing 210.

Specifically, in some embodiments, the forming part 230 may be provided as a plurality of forming parts. For example, the forming part 230 may be provided as 2 to 8 forming parts. The plurality of forming parts 230 can contribute to improving the process speed or implementing more complete bending of the electrode tab 140. In addition, in some embodiments, the plurality of forming parts 230 may be disposed to be spaced a predetermined interval from each other in the rotation direction of the rotation axis A2. For example, the plurality of forming parts 230 may be spaced the same interval from each other in the rotation direction of the rotation axis A2. In the illustrated embodiment, the number of forming parts 230 is illustrated as being four, and the four forming parts 230 are disposed to be spaced an interval of about 90 degrees from each other.

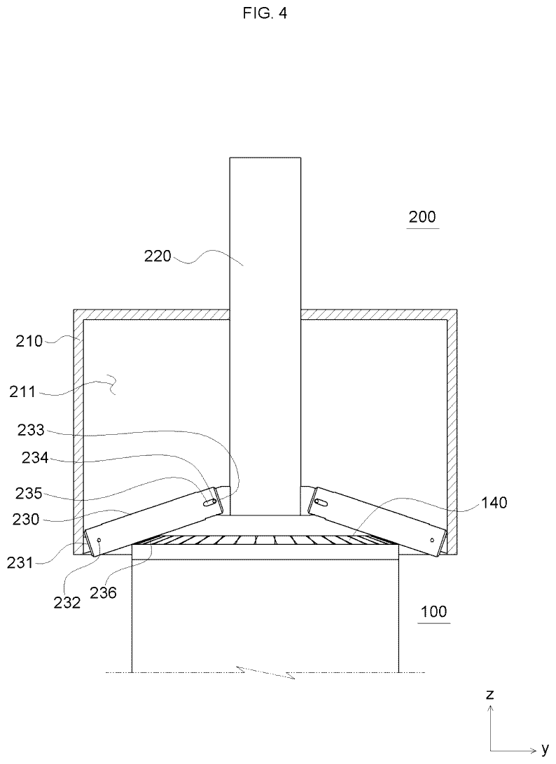

FIG. 4 is a first operation state diagram illustrating the operation of the apparatus for manufacturing a battery illustrated in FIG. 3.

Referring to FIG. 4, in some operating examples, the electrode assembly 100 may be disposed at a lower portion of the apparatus 200 for manufacturing a battery. In addition, the position of the electrode assembly 100 may be aligned so that the winding axis A1 corresponds to the rotation axis A2 of the apparatus 200 for manufacturing a battery.

In some operating examples, the angle adjuster 220 may be initially disposed at a position that is a predetermined amount higher than the housing 210. In addition, the forming part 230 may be disposed in a downward inclined state from the second end portion 233 toward the first end portion 231 according to the position of the angle adjuster 220.

In some operating examples, the apparatus 200 for manufacturing a battery may approach (move down) toward the electrode assembly 100 in the above state. The approach of the apparatus 200 for manufacturing a battery can be performed through the movement of the apparatus 200 for manufacturing a battery or the relative movement of the electrode assembly 100. In addition, in some operating examples, the vertical position of the apparatus 200 for manufacturing a battery may be maintained when approaching an appropriate processing position. For example, when the apparatus 200 for manufacturing a battery approaches a position at which the forming part 230 may properly come into contact with the electrode tab 140, the position of the apparatus 200 for manufacturing a battery may be maintained at the corresponding position.

In some operating examples, when the apparatus 200 for manufacturing a battery properly approaches the electrode assembly 100 as described above, the forming part 230 may be rotated about the rotation axis A2. In some operating examples, the forming part 230 may be rotated by the rotation of the housing 210 about the rotation axis A2. That is, as the housing 210 rotates about the rotation axis A2, the forming part 230 may rotate about the rotation axis A2. In addition, in some operating examples, the angle adjuster 220 may also rotate about the rotation axis A2. Accordingly, the forming part 230 may rotate about the rotation axis A2 in a state in which the first and second end portions 231 and 233 are fastened to the housing 210 and the angle adjuster 220, respectively. That is, the forming part 230 may move in the circumferential direction centered on the rotation axis A2.

In some operating examples, the forming part 230 may come into contact with the electrode tab 140 and bend the electrode tab 140. Specifically, in the illustrated operating example, the forming part 230 may be first come into contact with the electrode tab 140 in an area adjacent to the first end portion 231. Here, the electrode tab 140 that comes into contact with the forming part 230 may be generally disposed on the outer circumferential side according to the inclined arrangement of the forming part 230. In some operating examples, the forming part 230 may rotate in a state where it comes into contact with or is able to come into contact with the electrode tab 140. Accordingly, the electrode tab 140 disposed on the outer circumferential side may be bent toward the rotation axis A2 while in contact with the forming part 230.

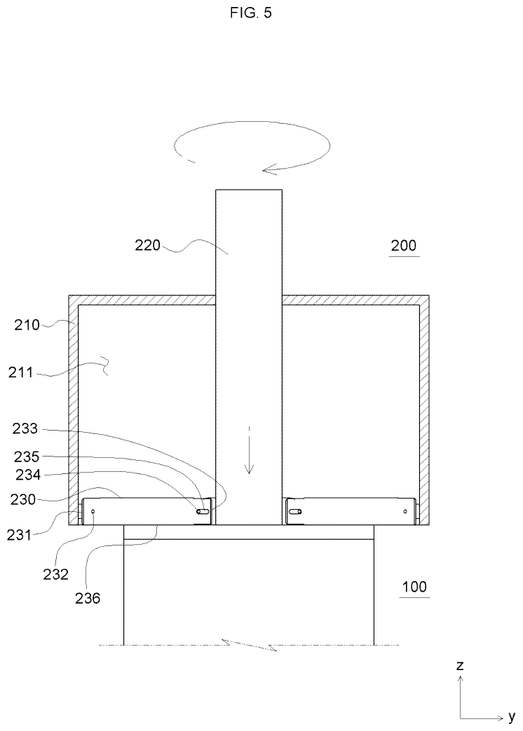

FIG. 5 is a second operation state diagram illustrating the operation of the apparatus for manufacturing a battery illustrated in FIG. 3.

Referring to FIG. 5, in some operating examples, the arrangement angle of the forming part 230 may vary. In some operating examples, the arrangement angle may be changed stepwise or gradually. Specifically, in some operating examples, the angle adjuster 220 may move down toward the electrode tab 140 from the initial position. In addition, in some operating examples, the angle adjuster 220 may move down in a stepwise or gradual manner. For example, the angle adjuster 220 may move down in a stepwise manner at a preset interval with a predetermined time difference. Alternatively, the angle adjuster 220 may gradually move down at a preset speed. The arrangement angle of the forming part 230 may vary according to the downward movement of the angle adjuster 220.

In some operating examples, as the angle adjuster 220 moves down in a stepwise or gradual manner, the arrangement angle of the forming part 230 may vary in a stepwise or gradual manner. In addition, in some operating examples, as the angle adjuster 220 moves down, the second end portion 233 of the forming part 230 may move down. Accordingly, the arrangement angle of the forming part 230 with respect to the transverse direction may gradually decrease.

In some operating examples, as the arrangement angle varies, the forming part 230 may come into contact with the electrode tab 140 disposed on an inner circumferential side. That is, as the second end portion 233 moves down, the forming part 230 may be come into contact with the electrode tab 140 disposed on the inner circumferential side that is further away from the first end portion 231. In addition, the forming part 230 may rotate while in contact with the electrode tab 140 disposed on the inner circumferential side to bend the electrode tab 140 disposed on the inner circumferential side.

In some operating examples, the forming part 230 may sequentially come into contact with the electrode tabs 140 up to the innermost electrode tab 140 as the arrangement angle of the forming part 230 varies as described above. Accordingly, the plurality of electrode tabs 140 may be sequentially bent in the order of the electrode tab 140 disposed on an outer circumferential side to the electrode tab 140 disposed on the inner circumferential side. In some operating examples, the arrangement angle of the forming part 230 may vary until it is substantially parallel to the transverse direction. That is, the forming part 230 may completely come into contact with the plurality of electrode tabs 140 while the arrangement angle thereof gradually varies from an initial state of being disposed in an oblique direction to a state of being parallel to the transverse direction. Accordingly, all the plurality of electrode tabs 140 disposed on one surface of the electrode assembly 100 may be bent toward the winding axis A1.

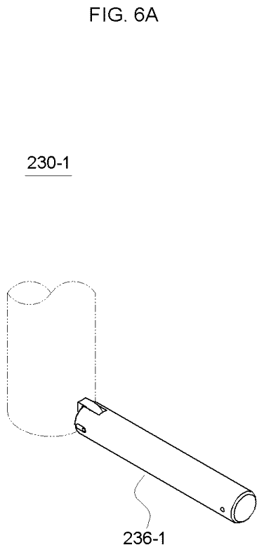

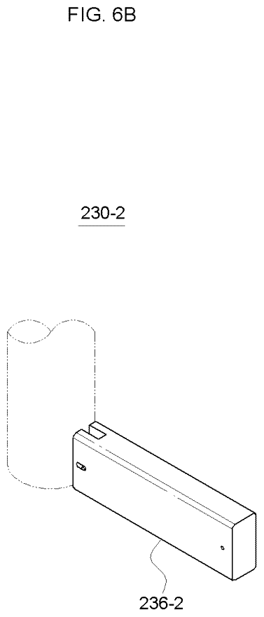

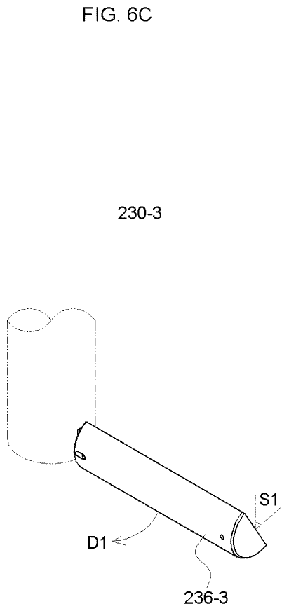

FIGS. 6A to 6C are schematic perspective views illustrating modified examples of the forming part illustrated in FIG. 3.

Referring to FIGS. 6A to 6C, the forming part 230 may be modified into various shapes as needed. In the modified example illustrated in FIG. 6A, a forming part 230-1 may have a substantially circular cross section and may be formed to extend in the longitudinal direction. In the illustrated modified example, a pressing surface 236-1 may be provided as a curved surface according to the cross-sectional shape of the forming part 230-1.

In the modified example illustrated in FIG. 6B, a forming part 230-2 may have a substantially rectangular cross section and may be formed to extend in the longitudinal direction. In the illustrated modified example, a pressing surface 236-2 may be provided on a bottom surface of the forming part 230-2. In addition, a bottom edge of the forming part 230-2 corresponding to the pressing surface 236-2 may be rounded to have a gentle curved surface.

In the modified example illustrated in FIG. 6C, a forming part 230-3 may have a substantially semicircular cross section and may be formed to extend in the longitudinal direction. In the illustrated modified example, a pressing surface 236-3 may be provided on a curved area of the forming part 230-3. In addition, in the illustrated modified example, the forming part 230-3 may be disposed in an attitude rotated at a predetermined angle S1 about the longitudinal direction so that the pressing surface 236-3 faces a movement direction D1 of the forming part 230-3.

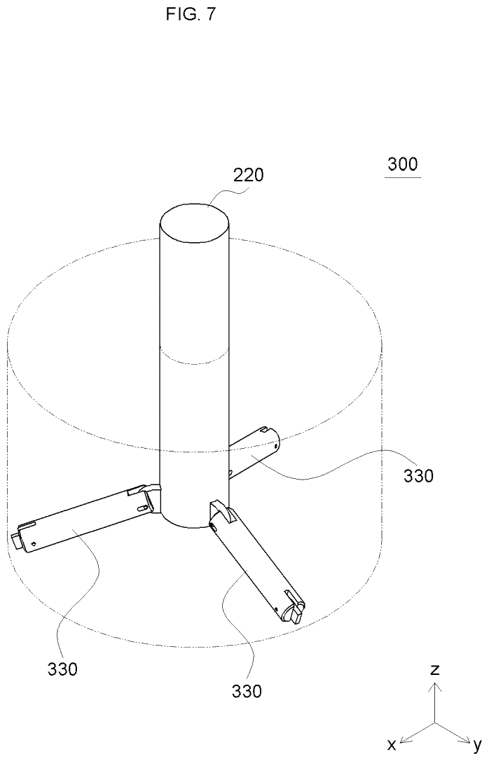

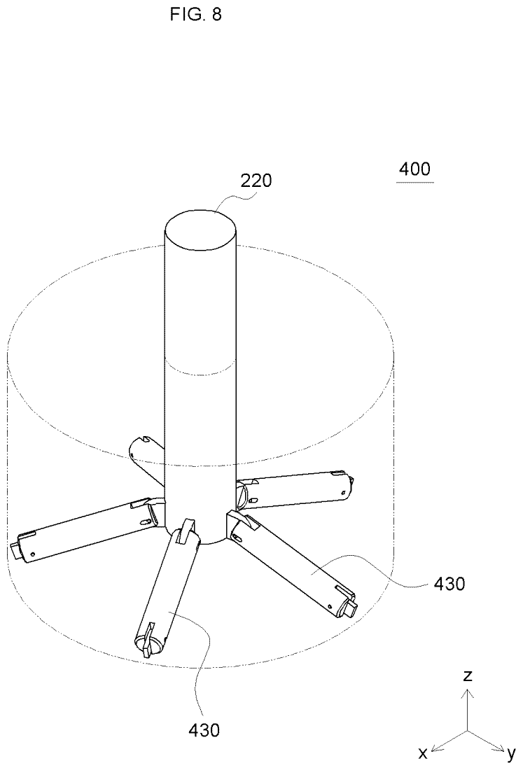

FIG. 7 is a schematic perspective view illustrating an apparatus for manufacturing a battery according to another embodiment of the present disclosure. FIG. 8 is a schematic perspective view illustrating an apparatus for manufacturing a battery according to still another embodiment of the present disclosure.

Referring to FIGS. 7 and 8, in some embodiments, forming parts 330 and 430 may be provided as a plurality of forming parts. The number of forming parts 330 and 430 may be appropriately selected in consideration of the process speed or the bending effect on the electrode tab 140. For example, in the embodiment illustrated in FIG. 7, the forming part 330 may be provided as three forming parts, and the three forming parts 330 may be disposed at intervals of about 120 degrees in the rotation direction. As another example, in the embodiment illustrated in FIG. 8, the forming part 430 may be provided as five forming parts, and the five forming parts 430 may be disposed at intervals of about 72 degrees in the rotation direction.

Although not illustrated, in some other embodiments, some of the plurality of forming parts may be disposed to have different intervals. In addition, some of the plurality of forming parts may be provided to have different sizes, shapes, materials, etc. from other forming parts.

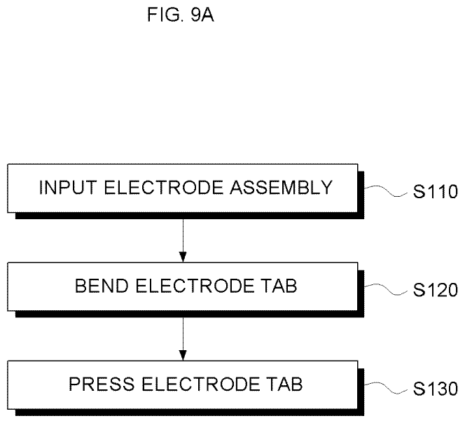

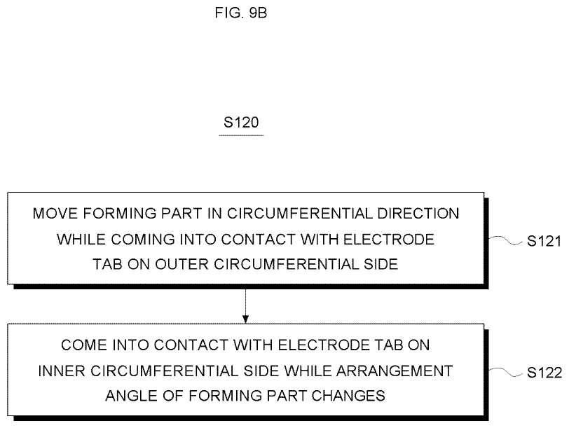

FIGS. 9A and 9B are schematic flowcharts illustrating a method of manufacturing a battery according to one embodiment of the present disclosure.

Referring to FIGS. 9A and 9B, according to another aspect of the present disclosure, a method of manufacturing a battery may be provided. In some embodiments, the method of manufacturing a battery may include an inputting operation S110 of inputting the electrode assembly 100 having a plurality of electrode tabs 140 disposed on at least one surface thereof. In addition, the method of manufacturing a battery may include a bending operation S120 of bending the plurality of electrode tabs 140 by the forming part 230. Here, the bending operation S120 may be performed while the arrangement angle of the forming part 230 is gradually changed.

In some embodiments, the method of manufacturing a battery may be performed through the apparatuses 200, 300, and 400 for manufacturing a battery of the above embodiments. Accordingly, in the following description, any description that overlaps the above description will be omitted or briefly summarized. However, the method of manufacturing a battery below does not necessarily need to be performed using the apparatuses 200, 300, and 400 for manufacturing a battery of the above embodiments. In some cases, the method of manufacturing a battery below may be performed through a different means from the apparatuses 200, 300, and 400 for manufacturing a battery of the above embodiments.

In some embodiments, the method of manufacturing a battery may include the inputting operation S110. In the inputting operation S110, the electrode assembly 100 may be input to a processing location. In some embodiments, the electrode assembly 100 may be provided similarly to that described above through FIG. 1.

Meanwhile, in some embodiments, the method of manufacturing a battery may include the bending operation S120. In the bending operation S120, the plurality of electrode tabs 140 provided on the electrode assembly 100 may be bent. In some embodiments, the bending of the plurality of electrode tabs 140 may be performed through the apparatuses 200, 300, and 400 for manufacturing a battery of the above embodiments. In addition, in some embodiments, the bending operation S120 may be performed while the arrangement angle of the forming part 230 is gradually changed. That is, the bending operation S120 may be performed while the forming part 230 initially disposed in an inclined direction gradually approaches and comes into contact with the electrode tab 140. Such a method has been described through the apparatuses 200, 300, and 400 for manufacturing a battery of the above embodiments.

In some embodiments, the bending operation S120 may include an operation S121 of moving the forming part 230 in a circumferential direction while preferentially coming into contact with the electrode tab 140 disposed on an outer circumferential side. In addition, the bending operation S120 may include an operation S122 of gradually changing the arrangement angle of the forming part 230 so that the forming part 230 moves in the circumferential direction while coming into contact with the electrode tab 140 disposed on an inner circumferential side. Such a method has been described through the apparatuses 200, 300, and 400 for manufacturing a battery of the above embodiments.

In addition, in some embodiments, the forming part 230 may be provided as a plurality of forming parts. In addition, the bending operation S120 may be performed so that the electrode tab 140 is repeatedly bent while the plurality of forming parts 230 move in the circumferential direction. The plurality of forming parts 230 can contribute to improving the process speed or the bending effect on the electrode tab 140. An example in which the plurality of forming parts 230 are provided has been described above with reference to FIGS. 7 and 8.

Meanwhile, in some embodiments, the method of manufacturing a battery may further include a pressing operation S130 of pressing, by the forming parts 230, the plurality of bent electrode tabs 140. In addition, in some embodiments, the pressing operation S130 may be performed so that the forming parts 230 are disposed in a direction orthogonal to the winding axis A1 of the electrode assembly 100 and the forming parts 230 disposed in this way move in the circumferential direction centered on the winding axis A1.

Specifically, in some embodiments, the method of manufacturing a battery may further include the pressing operation S130. In some embodiments, the pressing operation S130 may be performed sequentially after the bending operation S120. In addition, in some embodiments, the pressing operation S130 may be performed while the plurality of forming parts 230 are disposed in the direction orthogonal to the winding axis A1 of the electrode assembly 100. That is, the plurality of bent electrode tabs 140 may form the approximate flat surface on one surface of the electrode assembly 100, and in the pressing operation S130, the plurality of forming parts 230 may be disposed transversely to correspond to the approximate flat surface.

In some embodiments, the pressing operation S130 may be performed while the plurality of forming parts 230 disposed as described above move in the circumferential direction. That is, in the pressing operation S130, the plurality of forming parts 230 may move in the circumferential direction centered on the rotation axis A2. In some embodiments, the plurality of forming parts 230 may rotate a preset number of times. In addition, as needed, the plurality of forming parts 230 may rotate while moving down a predetermined amount toward the plurality of electrode tabs 140 or applying a predetermined downward pressing force. The plurality of bent electrode tabs 140 may be appropriately pressed by the forming parts 230 and transformed into a more complete bending state. In addition, the connecting surface S1 of the electrode assembly 100 may form a more complete flat surface state.

In some embodiments, the bending operation S120 and the pressing operation S130 may be repeatedly performed on each electrode tab 140 of the electrode assembly 100. For example, when the positive electrode tab 111 is disposed on one surface (the upper surface) of the electrode assembly 100 and the negative electrode tab 121 is disposed on the corresponding opposite surface (the bottom surface), the bending operation S120 and the pressing operation S130 may be repeatedly performed on one surface on which the positive electrode tab 111 is disposed and the opposite surface on which the negative electrode tab 121 is disposed. In some embodiments, after the one surface of the electrode assembly 100 is processed, the direction may be changed, and the electrode assembly may be re-input to process the opposite surface in the bending operation S120.

As described above, some embodiments of the present disclosure may provide an apparatus and method for manufacturing a battery.

In addition, some embodiments of the present disclosure may provide an apparatus and method for manufacturing a battery, which may be used to bend a plurality of electrode tabs during a process of manufacturing an electrode assembly.

In addition, some embodiments of the present disclosure may provide an apparatus and method for manufacturing a battery, which are capable of increasing a process speed. In some embodiments, the apparatus for manufacturing a battery, etc. can contribute to improving the process speed in such a manner that a forming part sequentially bends a plurality of electrode tabs.

In addition, some embodiments of the present disclosure may provide an apparatus and method for manufacturing a battery, which are capable of improving processing quality. In some embodiments, the apparatus for manufacturing a battery, etc. may be provided to sequentially bend a plurality of electrode tabs from an outer circumferential side toward an inner circumferential side, and such a method can contribute to improving processing quality during the bending processing of the electrode tabs.

In addition, some embodiments of the present disclosure may provide an apparatus and method for manufacturing a battery, which are capable of improving the performance or quality of a processed battery. In some embodiments, the apparatus for manufacturing a battery, etc. can serve to more effectively and completely bend a plurality of electrode tabs provided in an electrode assembly, and such a characteristic can contribute to improving the performance or quality of a processed battery.

Some embodiments of the present disclosure can provide an apparatus and method for manufacturing a battery.

In addition, some embodiments of the present disclosure can provide an apparatus and method for manufacturing a battery, which can be used to bend a plurality of electrode tabs during a process of manufacturing an electrode assembly.

In addition, some embodiments of the present disclosure can provide an apparatus and method for manufacturing a battery, which are capable of increasing a process speed.

In addition, some embodiments of the present disclosure can provide an apparatus and method for manufacturing a battery, which are capable of improving processing quality.

In addition, some embodiments of the present disclosure can provide an apparatus and method for manufacturing a battery, which are capable of improving the performance or quality of a processed battery.

The above descriptions are merely examples of applying the principle of the present disclosure, and other configurations may be further included without departing from the scope of the present disclosure.

What is claimed is:

1. An apparatus for manufacturing a battery, comprising:
a housing;
an angle adjuster provided to be movable with respect to the housing; and
a forming part disposed between the housing and the angle adjuster and having an arrangement angle that varies according to movement of the angle adjuster to bend a plurality of electrode tabs provided in an electrode assembly.

2. The apparatus of claim 1, wherein the housing includes an internal space in which the angle adjuster and the forming part are disposed.

3. The apparatus of claim 1, wherein the housing is provided to be rotatable with respect to the electrode assembly about a rotation axis in a first direction.

4. The apparatus of claim 1, wherein the angle adjuster is disposed in a central portion of the housing and provided to be movable in a first direction with respect to the housing.

5. The apparatus of claim 1, wherein the angle adjuster is provided to gradually move from an initial position toward the electrode assembly according to rotation of the housing to change the arrangement angle of the forming part.

6. The apparatus of claim 1, wherein the forming part includes a first end portion fastened to the housing, and
the first end portion is rotatably fastened to the housing through a first hinge shaft.

7. The apparatus of claim 6, wherein the first hinge shaft is provided to be orthogonal to a movement direction of the angle adjuster.

8. The apparatus of claim 1, wherein the forming part includes a second end portion fastened to the angle adjuster, and
the second end portion is rotatably fastened to the angle adjuster through a second hinge shaft.

9. The apparatus of claim 8, wherein the second hinge shaft is provided to be orthogonal to a movement direction of the angle adjuster.

10. The apparatus of claim 8, wherein the second hinge shaft is movably fastened to a slot disposed in the second end portion, and
the slot is formed to extend in a longitudinal direction of the forming part.

11. The apparatus of claim 10, wherein the second hinge shaft is formed to move within the slot in conjunction with the movement of the angle adjuster.

12. The apparatus of claim 1, wherein the forming part includes:
a first end portion rotatably fastened to the housing through a first hinge shaft; and
a second end portion rotatably fastened to the angle adjuster through a second hinge shaft, and
the second hinge shaft is movably fastened to a slot disposed in the second end portion and moves within the slot according to the movement of the angle adjuster.

13. The apparatus of claim 1, wherein the forming part includes a pressing surface that comes into contact with the electrode tabs, and
at least a part of the pressing surface has a curved surface to relieve damage to the electrode tabs during bending of the electrode tabs.

14. The apparatus of claim 13, wherein the pressing surface includes a coating layer.

15. The apparatus of claim 1, wherein the forming part is provided as a plurality of forming parts, and
the plurality of forming parts are provided to repeatedly bend the electrode tabs according to rotation of the housing.

16. A method of manufacturing a battery, comprising:
inputting an electrode assembly in which a plurality of electrode tabs are disposed on at least one surface thereof; and
bending, by a forming part, the plurality of electrode tabs,
wherein the bending of the plurality of electrode tabs is performed while an arrangement angle of the forming part is gradually changed.

17. The method of claim 16, wherein the bending of the plurality of electrode tabs includes:
moving the forming part in a circumferential direction of the electrode assembly while preferentially coming into contact with the electrode tab disposed on an outer circumferential side of the electrode assembly; and
gradually changing the arrangement angle of the forming part and moving the forming part in the circumferential direction while coming into contact with the electrode tab disposed on an inner circumferential side of the electrode assembly.

18. The method of claim 16, wherein the forming part is provided as a plurality of forming parts, and
the bending of the plurality of electrode tabs is performed to repeatedly bend the electrode tabs while the plurality of forming parts move in a circumferential direction of the electrode assembly.

19. The method of claim 16, further comprising pressing, by the forming part, the plurality of bent electrode tabs.

20. The method of claim 19, wherein the pressing of the plurality of bent electrode tabs is performed in such a manner that the forming part is disposed in a direction orthogonal to a winding axis of the electrode assembly and the forming part moves in a circumferential direction centered on the winding axis.
